(19) United States
(12) Patent Application Publication
(10) Pub. No.: US 2004/0141899 A1
(43) Pub. Date: Jul. 22, 2004

(54) Device and method for processing toxic gasses in vortex reacting chamber

(75) Inventor: Tien Lei, Longtan Township (TW)

Correspondence Address: TROXELL LAW OFFICE PLLC, SUITE 1404, 5205 LEESBURG PIKE, FALLS CHURCH, VA, 22041, US

(73) Assignee: Desiccant Technology Corporation

(21) Appl. No.: 10/754,729

(22) Filed: Jan. 12, 2004

(30) Foreign Application Priority Data
Jan. 3, 2003 (TW) 092100295

(51) Int. Cl. B01D 53/70; F01N 3/00; C01B 7/00

(52) U.S. Cl. 423/240 R; 422/168; 422/186

(57) ABSTRACT

This invention provides a device and a method for processing toxic gasses in a vortex reacting chamber, where gases entering the reacting chamber are introduced into the reacting chamber along a tangential direction, such that that forces generated by a velocity field caused by the gases may be used to clean the fine solid molecules attached to the reactor inner wall that the gasses subsequently pass through, for reducing accumulation of the fine solid molecules produced by toxic gasses during pyrolysis unto the reactor inner wall thereby postponing the periodical cleaning required by the reactor. In addition, this invention discloses an effective measure for processing the fine molecules washed off from the reacting chamber inner wall by dividing the subsequently water tank set into two functional sections, including a first water tank and second water tank, so as to effectively carry away all fine molecules suspended above the water level within the water tank set.

### CROSS-REFERENCES TO RELATED APPLICATIONS

Not Applicable

### STATEMENT REGARDING FEDERALLY SPONSORED RESEARCH OR DEVELOPMENT

Not Applicable

### DESCRIPTION

### FIELD OF INVENTION

This invention relates to a device and a method for processing toxic gasses in a vortex reacting chamber, particularly to a method for cleaning the reactor inner wall by introducing gases into a reacting chamber without application of external forces, for reducing accumulation of the fine solid molecules produced by toxic gasses during pyrolysis unto the reactor inner wall thereby postponing the periodical cleaning required by the reactor.

### BACKGROUND

Perfluorocompounds (PFCs) are one of the greenhouse gases under surveillance. SF₆, HFCs and PFCs are the primary man-made greenhouse constituents. Though HFCs and PFCs do not deteriorate the ozone layer, they are considered high effective greenhouse gases with a Global Warming Potential (GWP) thousand times higher than CO₂; they possess an extensive life cycle and are able to suspend in the atmosphere for a suspended period of time to produce irreversible effects as a result of their accumulation in the atmosphere. In recent years, the production of semiconductors (such as in the process for cleaning dry-etched CVD chambers) regularly utilizes PFCs, such as CF₄, C₂F₆, C₃F₈ or NF₃ as the processing gases, while very few of which gases are actually depleted during the manufacturing process and the majority of which, such as 90% of the gasses utilized during the CVD process, are discharged as exhausts thereby forming a primary source of the greenhouse effects. Nations that are active in the manufacturing of semiconductors have reached a mutual understanding and agreed upon the formulation of regulations to reduce emission of PFCs gasses. The semiconductor industry in Taiwan will also be subjected to the restraints of such an agreement. However, along with the on-going developments of manufacturing semiconductors, the PFCs consumption grows with each passing day. Hence, it is necessary to control and deal with such toxic gasses to prevent environmental contamination, such as implementing new PFCs exhaust processing system to act in response to the increasingly stringent emission standards.

The currently available devices that are most effective in processing toxic gas exhaust are designed based on the principles of high temperature pyrolysis by implementing high energy density plasma to serve the cleaning and detoxicating purposes. The device in FIG. 1 is characterized by the introduction of the exhaust that directly reacts with the plasma prior to entering the reacting chamber. A water injector assembly is provided at an outlet oft he reacting chamber for reducing the exhaust temperature upon passing through the water injector assembly. The exhaust is then introduced into and processed in a wet washing tower prior to drainage, wherein a water tank is provided to the wet washing tower for supplying circulating water.

The device is operated as follows. The reactor 110 includes an exhaust inlet 111, a plasma torch 112 and a reacting chamber 113, wherein the reacting chamber interior is constructed of refractory materials, the extremely high temperature plasma stream produced by the plasma torch 112 subjects the toxic gas exhaust entering through the exhaust inlet 111 to instantaneous pyrolysis, atomization or ionization in the reacting chamber 113 to produce exhaust products including H₂, CO, CO₂ and HF. Then, a water injector assembly 120 is provided at an outlet of the reacting chamber 113 of the reactor 110. The water vapor injected by the water injector assembly 120 would absorb the thermal energy to rapidly reduce the products temperature and to dissolve a part of HF in the exhaust products, while the remaining exhaust products precipitating above the water tank surface are then drained along with the wastewater by means of bottom draining. Because temperature would affect the extent of gaseous dissolution, the exhaust products after being cooled by the water vapor pass through a filter 140 to strain away impurities and solids contained therein. The exhaust is then introduced into a wet washing tower 150 that is filled therein with filler having a high surface area. Solids, such as silicon powders, carried by the toxic gas exhaust would be cleaned and strained away when the exhaust products pass through the wet washing tower 150 that absorbs HF at the same time. To facilitate processing of HF, lye may be added to the injected water vapor to neutralize the acidity resulted from HF. Under most circumstances, for plants that are equipped with wastewater processing stations, wastewater containing fluorides may be processed by the wastewater processing stations. Hence, the water stored in the water tank may be drained by batches or continuously to the wastewater processing stations. When there is an insufficient gas flow static pressure from the exhaust source, a windmill 160 may be added to a downstream of the wet washing tower 150 to make up a deficiency of the static pressure and to assist in discharging the desired volume.

However, in the prior art, to improve the processing efficiency of the toxic gases, the toxic gases, such as C₂F₆, SiH₄, CF₄, NF₃ and CHF₃, produced by the semiconductor and other industries are commonly processed in the reactor at the same time in accordance with the following equations:

C₂F_{6(g)}+4H₂O_{(g)}--->6 HF_{(g)}+2CO_{2(g)}+H_{2(g)};

SiH_{4(g)}+2H₂O_{(g)}--->SiO₂₍ₛ₎+4H_{2(g)};

CF_{4(g)}+2H₂O_{(g)}--->4HF_{(g)}+CO_{2(g)}; and

CHF_{3(g)}+2H₂O_{(g)}--->3HF_{(g)}+CO_{2(g)}+H_{2(g)},

in which all exhaust products in the equations are gases. To remove solid SiO₂ that is easily attached to the reactor inner wall upon pyrolysis of SiH₄, the inner wall must be frequently cleaned to ensure reactor performance thereby resulting in the shortcomings of reducing the lifespan of the equipment and increasing the operation cost.

### SUMMARY OF INVENTION

It is a primary objective of this invention to provide a device and a method for processing toxic gasses in a vortex reacting chamber by introducing gases into a reacting chamber without application of external forces to clean the fine solid molecules attached to the reactor inner wall during reaction.

It is another objective of this invention to provide a device and a method for processing toxic gasses in a vortex reacting chamber that implements forces generated by a velocity field caused by the gases to clean the fine solid molecules attached to the reactor inner wall.

It is another objective of this invention to provide a device for processing toxic gasses in a vortex reacting chamber, in which a connecting conduit is provided between a first water tank and a second water tank to effectively drain the fine molecules from the first water tank.

This invention adopts the following measures to achieve the above objectives. First, the exhaust and plasma torch are introduced to the reaction chamber to cause instantaneous pyrolysis of the exhaust thereby producing fine solid molecules that are easily attached to the chamber interior surface. To facilitate cleaning of such solid molecules, the reacting chamber is formed with plural reacting chamber gas inlets for introducing gasses to clean the fine solid molecules attached to the inner wall. Then, the exhaust after the combustion reaction precipitates into the first water tank. Water vapor injected by a water injector assembly provided in the first water tank absorbs thermal energy to rapidly reduce the products temperature and to dissolve a part of HF in the exhaust products. Because temperature would affect the extent of gaseous dissolution, the exhaust products after being cooled by the water vapor pass through a first water tank and a filter to strain away impurities and solids contained therein. The exhaust is then introduced into a wet washing tower. Solids, such as silicon powders, carried by the exhaust products would be cleaned and strained away when the exhaust products pass through the wet washing tower that absorbs HF at the same time.

### BRIEF DESCRIPTION OF THE DRAWINGS

These and other modifications and advantages will become even more apparent from the following detained description of a preferred embodiment of the invention and from the drawings in which:

FIG. 1 is a schematic view illustrating a conventional device for processing toxic gas exhaust.

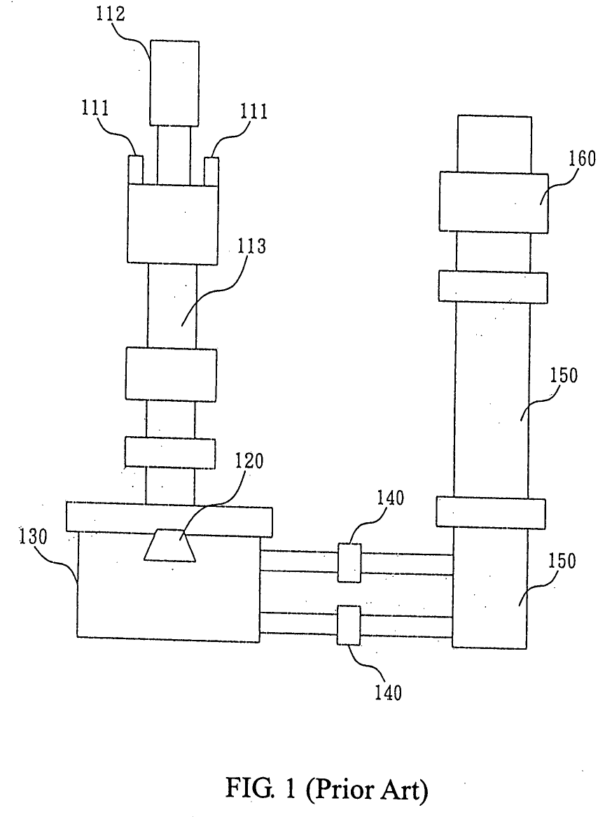

FIG. 2 is a schematic view illustrating the device for incinerating toxic gas exhaust according to an embodiment of this invention.

FIGS. 3A and 3B are sketches simulating the velocity fields at an upstream and a downstream taken along the front cross-sections of the outlets according to the disclosure of this invention.

### DETAILED DESCRIPTION OF THE INVENTION (PREFERRED EMBODIMENTS)

This invention may be implemented by plants to process PFCs exhaust, by introducing gases to form vortex airflow for cleaning exhaust products that are attached to the reaction chamber inner wall during combustion of the PFCs.

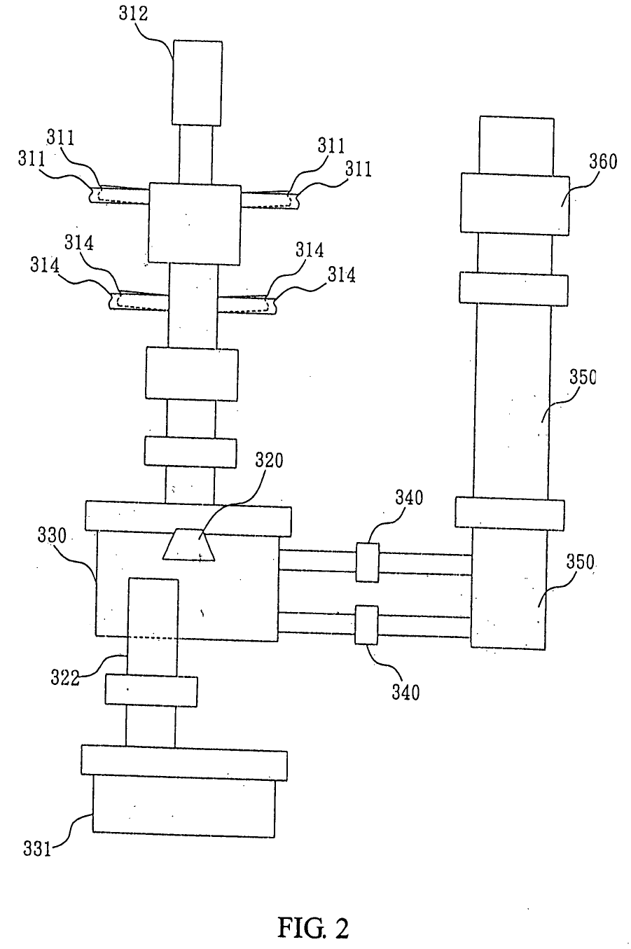

FIG. 2 is a schematic view illustrating the device for incinerating toxic gas exhaust produced by manufacturing plants according to an embodiment of this invention. Similar to a conventional device for incinerating toxic gas exhaust, the exhaust is introduced to directly react with plasma prior to entering the reacting chamber. A water injector assembly is provided at an outlet of the reacting chamber for reducing the temperature of the exhaust and the fine solid molecules carried by the exhaust products upon passing through the water injector assembly. The exhaust is then introduced into and processed in a wet washing tower prior to drainage, wherein a water tank is provided to the wet washing tower for supplying circulating water. The features that distinguish this invention from the prior device reside in that, this invention implements forces generated by a velocity field caused by the gases to clean the fine solid molecules attached to the reactor inner wall. The measures adopted by this invention are as follows.

A plasma reactor 310 includes: an exhaust inlet 311, a plasma torch 312, a reacting chamber 313 and a reacting chamber gas inlet 314. The reacting chamber interior is constructed of refractory materials. A high temperature ambient is achieved under heating of the plasma torch. The toxic gas exhaust enters the reacting chamber 313 through the exhaust inlet 311 and passes through the extremely high temperature plasma stream (about 10,000° C.) produced by the plasma torch 312. The toxic gas exhaust is subject to instantaneous pyrolysis, atomization or ionization in the reacting chamber 313 thereby destructing the chemical bonds to become molecules or atoms that are easily processed, such as CO, CO₂ and HF as well as fine solid molecules that are easily attached to the chamber interior surface.

To assist in cleaning the solid molecules attached to the chamber interior surface, the reacting chamber 313 according to this invention is formed with more than one reacting chamber gas inlets 314 that are situated normally to the chamber body for introduction of gases along a tangential direction of the reacting chamber into the reacting chamber, such that that forces generated by a velocity field caused by the gases may be used to clean the fine solid molecules attached to the reactor inner wall that the gasses subsequently pass through. The negative pressure within the reacting chamber 313 during the combustion of the exhaust allows introduction of the gasses into the reacting chamber 313 through the reacting chamber gas inlets 314 without application of any external forces. The gasses introduced into the reacting chamber 313 mainly consist of inactive gases that do not participate in the reaction, such as N₂.

To facilitate cleaning of the fine solid molecules in the reacting chamber, features similar to the reacting chamber gas inlets 314 may also be implemented in the exhaust inlet 311 if it is undesirable to provide the gas inlets 314 to the reacting chamber gas inlets 314 of the reacting chamber 313. In other words, the exhaust inlet 311 may be situated normally to the reacting chamber 313, such that forces generated by a velocity field caused by the exhaust may be used to clean the fine solid molecules attached to the reactor inner wall that the exhaust subsequently passes through.

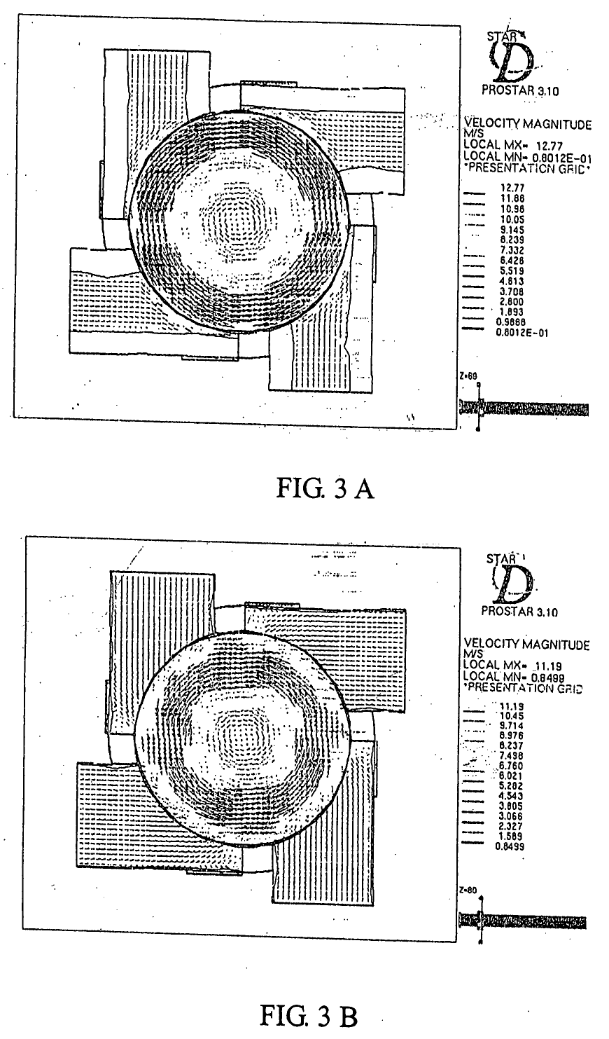

FIGS. 3A and 3B are sketches simulating the velocity fields where four exhaust inlets are provided to the reaction chamber with an inlet volume of 50 LPM according to the disclosure of this invention. As shown in FIGS. 3A and 3B, the gases introduced into the reaction chamber can indeed achieve the objective of cleaning the inner wall.

The exhaust products after the combustion reaction then precipitate into a first water tank 330. Water vapor injected by a water injector assembly 320 provided in the first water tank 330 absorbs thermal energy to rapidly reduce the products temperature and to dissolve a part of HF in the exhaust products. Because temperature would affect the extent of gaseous dissolution, the exhaust products after being cooled by the water vapor pass through a first water tank 330 and a filter 340 to strain away impurities and solids contained therein. The exhaust is then introduced into a wet washing tower 350 that is filled therein with filler having a high surface area. Solids, such as silicon powders, carried by the exhaust products would be cleaned and strained away when the exhaust products pass through the wet washing tower 350 that absorbs HF at the same time. To facilitate processing of HF, lye may be added to the injected water vapor to neutralize the acidity resulted from HF

Under the influence of high temperature, the fine solid molecules contained in the exhaust products would fall and suspend above the water level to cause difficulty in draining these fine solid molecules by means of bottom draining, thereby affecting the absorption performance of the wet washing tower. Hence, the solution consisting of the fine solid molecules and water in the first water tank 330 is then carried into a second water tank 331 through a connecting conduit 332 having an opening projecting towards the water level from the bottom of the first water tank, to settle the fine molecules in the second water tank 331. After an appropriate period of time, the fine molecules would precipitate to a bottom of the second water tank 331, which are then drained along with the wastewater by means of bottom draining to effectively carry away all fine molecules. The remaining exhaust products and solids carried by the exhaust products that are non-dissolvable, such as silicon powders, are then guided into the wet washing tower 350 through the filter 340 to complete the subsequent processing procedure. Gases that are in compliance with environmental standards are then discharged by means of a windmill 360. When there is an insufficient gas flow static pressure from the exhaust source, the windmill 360 may be added to a downstream of the wet washing tower 350 to make up a deficiency of the static pressure and to assist in discharging the desired volume.

Plasma is used is an example to describe the embodiment of this invention. However, any other combustion means, such as fuel gas and electro-heating may also be implemented in this invention. The same problems encountered by the used of fuel gas and electro-heating as the heating means during combustion may also be resolved by this invention.

This invention is related to a novel creation that makes a breakthrough in the art. Aforementioned explanations, however, are directed to the description of preferred embodiments according to this invention. Since this invention is not limited to the specific details described in connection with the preferred embodiments, changes and implementations to certain features of the preferred embodiments without altering the overall basic function of the invention are contemplated within the scope of the appended claims.

What is claimed is:

1. A method for processing toxic gasses in a vortex reacting chamber, comprising the steps of:
(a) subjecting exhaust to instantaneous pyrolysis for producing exhaust products by passing exhaust through a fire torch prior to entering a reacting chamber, the exhaust products consisting of gaseous molecules and fine solid molecules;
(b) introducing gases into the reacting chamber by means of a reacting chamber gas inlet, for forming a velocity field that generates forces to clean the fine solid molecules attached to the reactor inner wall;
(c) dissolving HF in gaseous modules in a water tank set and carrying away the fine solid molecules suspended above a normal water level within the water tank set; and
(d) processing the remaining gaseous modules and fine solid molecules by a wet washing tower.

2. The method for processing toxic gasses in a vortex reacting chamber of claim 1, wherein the reacting chamber includes an exhaust inlet, a fire torch, a reacting chamber and a reacting chamber gas inlet.

3. The method for processing toxic gasses in a vortex reacting chamber of claim 1, wherein the fire torch is produced by any of plasma, electro-heating and fuel gas.

4. The method for processing toxic gasses in a vortex reacting chamber of claim 1, wherein reacting chamber includes plural reacting chamber gas inlets.

5. The method for processing toxic gasses in a vortex reacting chamber of claim 1, wherein the reacting chamber are situated normally to the reacting chamber gas inlet such that the gases enter the reacting chamber along a tangential direction of the reaction chamber.

6. The method for processing toxic gasses in a vortex reacting chamber of claim 1, wherein the gases mainly consist of inactive gases, such as N₂.

7. The method for processing toxic gasses in a vortex reacting chamber of claim 1, wherein the water tank set includes a water tank connecting to the reacting chamber.

8. The method for processing toxic gasses in a vortex reacting chamber of claim 1, wherein the water tank set includes a first water tank and a second water tank, the first water tank, reacting chamber and second water tank being sequentially arranged from top down, wherein the first water tank and the second water tank are connected by a connector.

9. The method for processing toxic gasses in a vortex reacting chamber of claim 8, wherein the connector includes a top opening projecting towards the water level from a bottom of the first water tank to a level close to but beneath the normal water level, and a bottom opening connecting inside of the second water tank, for carrying away the fine molecules suspended above the water level in step (c).

10. A method for processing toxic gasses in a vortex reacting chamber, comprising the steps of:
(a) introducing exhaust into a reacting chamber by means of an exhaust inlet and subjecting the exhaust to pyrolysis by supplying heat through a fire torch to produce exhaust products consisting of gaseous molecules and fine solid molecules, the exhaust inlet being situated normally to the reacting chamber;
(b) dissolving HF in gaseous modules in a water tank set and carrying away the fine solid molecules suspended above a water level within the water tank set; and
(d) processing the remaining exhaust products by a wet washing tower.

11. The method for processing toxic gasses in a vortex reacting chamber of claim 10, wherein the reacting chamber includes an exhaust inlet, a fire torch and a reacting chamber.

12. The method for processing toxic gasses in a vortex reacting chamber of claim 10, wherein the fire torch is produced by any of plasma, electro-heating and fuel gas.

13. The method for processing toxic gasses in a vortex reacting chamber of claim 10, wherein reacting chamber includes plural exhaust inlets.

14. The method for processing toxic gasses in a vortex reacting chamber of claim 1, wherein the exhaust forms a velocity field that generates forces to clean the fine solid molecules attached to the reactor inner wall because the reacting chamber are situated normally to exhaust inlet.

15. The method for processing toxic gasses in a vortex reacting chamber of claim 10, wherein the water tank set includes a water tank connecting to the reacting chamber.

16. The method for processing toxic gasses in a vortex reacting chamber of claim 10, wherein the water tank set includes a first water tank and a second water tank, the first water tank, reacting chamber and second water tank being sequentially arranged from top down, wherein the first water tank and the second water tank are connected by a connector.

17. The method for processing toxic gasses in a vortex reacting chamber of claim 16, wherein the connector includes a top opening projecting towards the water level from a bottom of the first water tank to a level close to but beneath the normal water level, and a bottom opening connecting inside of the second water tank, for carrying away the fine molecules suspended above the water level in step (b).

18. A device for processing toxic gasses in a vortex reacting chamber, comprising:
a reacting chamber;
a reacting chamber gas inlet provided to the reacting chamber and situated normally to the reacting chamber such that gases are introduced into the reacting chamber along a tangential direction;
a water tank set, connecting to the reacting chamber; and
a wet washing tower, connecting to the water tank set;
wherein the exhaust is joined to a fire torch prior to entering the reacting chamber for reaction, and external gases not participated in the reaction are introduced into through the reacting chamber gas inlet to carry away fine solid molecules attached to a reacting chamber inner wall after the reaction; products produced during the reaction and precipitated in the water tank set are discharged after being subjected to filtering and settling processes and the remaining products are discharged after being introduced into the wet washing tower for processing.

19. The device for processing toxic gasses in a vortex reacting chamber of claim 18, wherein the reacting chamber includes at least one exhaust inlet and a fire torch.

20. The device for processing toxic gasses in a vortex reacting chamber of claim 18, wherein the reacting chamber includes plural reacting chamber gas inlets.

21. The device for processing toxic gasses in a vortex reacting chamber of claim 18, wherein the fire torch is produced by any of plasma, electro-heating and fuel gas.

22. The device for processing toxic gasses in a vortex reacting chamber of claim 18, wherein the external gases form a velocity field that generates forces to clean the reactor inner wall because the reacting chamber are normal to external gases.

23. The device for processing toxic gasses in a vortex reacting chamber of claim 18, wherein the gases mainly consist of inactive gases, such as N₂.

24. The device for processing toxic gasses in a vortex reacting chamber of claim 18, wherein the water tank set includes a first water tank and a second water tank, the first water tank, reacting chamber and second water tank being sequentially arranged from top down, wherein the first water tank and the second water tank are connected by a connector.

25. A device for processing toxic gasses in a vortex reacting chamber, comprising:
a reacting chamber, having an exhaust inlet provided to the reacting chamber and situated normally to the reacting chamber such that exhaust is
a water tank set, connecting to the reacting chamber; and
a wet washing tower, connecting to the water tank set;
wherein the exhaust is joined to a fire torch prior to entering the reacting chamber for reaction, and carries away fine solid molecules attached to a reacting chamber inner wall after the reaction; products produced during the reaction and precipitated in the water tank set are discharged after being subjected to filtering and settling processes and the remaining products are discharged after being introduced into and processed in the wet washing tower.

26. The device for processing toxic gasses in a vortex reacting chamber of claim 25, wherein the reacting chamber includes at least one exhaust inlet and a fire torch.

27. The device for processing toxic gasses in a vortex reacting chamber of claim 25, wherein the reacting chamber includes plural exhaust inlets.

28. The device for processing toxic gasses in a vortex reacting chamber of claim 27, wherein the fire torch is produced by any of plasma, electro-heating and fuel gas.

29. The device for processing toxic gasses in a vortex reacting chamber of claim 25, wherein the water tank set includes a water tank connecting to the reacting chamber.

30. The device for processing toxic gasses in a vortex reacting chamber of claim 25, wherein the water tank set includes a first water tank and a second water tank, the first water tank, reacting chamber and second water tank being sequentially arranged from top down, wherein the first water tank and the second water tank are connected by a connector.
